(19) United States
(12) Patent Application Publication
(10) Pub. No.: US 2014/0019027 A1
(43) Pub. Date: Jan. 16, 2014

(54) VEHICLE AND METHOD FOR CONTROLLING VEHICLE

(71) Applicant: Yasushi Kojima, Miyoshi-shi (JP)

(72) Inventor: Yasushi Kojima, Miyoshi-shi (JP)

(73) Assignee: TOYOTA JIDOSHA KABUSHIKI KAISHA, Toyota-shi, Aichi-ken (JP)

(21) Appl. No.: 14/007,570

(22) PCT Filed: Apr. 1, 2011
(86) PCT No.: PCT/JP2011/058430

§ 371 Date: Sep. 25, 2013

(51) Int. Cl. F02D 45/00

(52) U.S. Cl. CPC F02D 45/00
USPC 701/102

(57) ABSTRACT

A vehicle includes a motor generator for outputting driving force for running, a PCU for driving the motor generator, and an ECU for controlling the PCU. The ECU detects whether a driving wheel of the vehicle is passing over a bump on a road surface. In response to detecting that the vehicle is passing over a bump, the ECU controls the PCU such that an upper limit value of a running speed of the vehicle is restricted to a value lower than that when the vehicle is not passing over a bump.

### TECHNICAL FIELD

The present invention relates to a vehicle and a method for controlling a vehicle, and more specifically to drive control for a vehicle that can run with driving force from a rotating electric machine.

### BACKGROUND ART

In recent years, a vehicle having a power storage device (for example, a secondary battery, a capacitor, etc.) mounted thereon and runs with driving force generated from electric power stored in the power storage device is attracting attention as an environmentally friendly vehicle. Examples of such vehicles include an electric vehicle, a hybrid vehicle, a fuel-cell vehicle, and the like.

Generally, in such a vehicle, DC electric power from the power storage device is converted with an inverter into AC electric power for driving a rotating electric machine such as a motor generator. The vehicle is allowed to run with driving force generated by the rotating electric machine, and during regenerative braking, for example, rotating force from driving wheels, an engine, and the like is converted into electrical energy for charging the power storage device.

When the vehicle has to pass over a bump on a road surface during running with the driving force from the rotating electric machine, it is sometimes difficult for the vehicle to pass over the bump due to an insufficient output torque, especially during running at a low speed. Moreover, when the output torque is temporarily increased to pass over this bump, an excessive torque is sometimes required immediately after passing over the bump.

Japanese Patent Laying-Open No. 2006-296135 (Patent Document 1) discloses a parking assist apparatus for assisting automatic parking of a vehicle having a motor as a driving source. The parking assist apparatus is configured to control the motor by feedback control based on a rotation speed of the motor that is input by a driver's operation, and automatically moves the vehicle to a set location.

According to the technique disclosed in Japanese Patent Laying-Open No. 2006-296135 (Patent Document 1), with the parking assist apparatus for a vehicle, the vehicle does not stop due to an insufficient torque even on a slope or a road with a bump, automatic parking is not interrupted due to the speed exceeding an upper limit after the vehicle has passed over a bump, and the driver can adjust the moving speed of the vehicle.

### CITATION LIST

### Patent Document

PTD 1: Japanese Patent Laying-Open No. 2006-296135

PTD 2: Japanese Patent Laying-Open No. 9-048263

PTD 3: Japanese Patent Laying-Open No. 2007-030581

PTD 4: Japanese Patent Laying-Open No. 2007-045230

PTD 5: Japanese Patent Laying-Open No. 2007-230343

### SUMMARY OF INVENTION

### Technical Problem

Japanese Patent Laying-Open No. 2006-296135 (Patent Document 1), however, discloses a configuration in which the moving speed of the vehicle is set using an amount of operation of the brake pedal or accelerator pedal. After the vehicle has passed over the bump, therefore, the driver may experience a sense of discomfort, for example, the driver cannot gain a feeling of acceleration as expected.

The present invention was made to solve this problem, and an object of the invention is to allow a vehicle that can run with driving force from a rotating electric machine to advantageously pass over a bump.

### Solution to Problem

A vehicle according to the present invention is a vehicle that can run with driving force output from a rotating electric machine mounted thereon, including a drive device for driving the rotating electric machine and a control device for controlling the drive device. When the vehicle is passing over a bump on a road surface, the control device controls the drive device such that an upper limit value of a running speed of the vehicle is restricted to a value lower than that when the vehicle is not passing over a bump.

Preferably, the vehicle further includes an accelerator pedal. Under a prescribed condition where a parameter associated with a rotation speed of a driving wheel of the vehicle is equal to or smaller than a prescribed value and an amount of operation of the accelerator pedal is greater than a prescribed amount of operation corresponding to an inclination of the vehicle, the control device determines that the vehicle is passing over the bump, and controls the drive device such that the upper limit value of the running speed of the vehicle is restricted to a value lower than that when the vehicle is not passing over the bump.

Preferably, the control device determines that the vehicle is passing over the bump when the prescribed condition is met, and the prescribed condition lasts for a predetermined period.

Preferably, the control device releases a restriction on the running speed of the vehicle, based on information indicating completion of passing over the bump.

Preferably, the vehicle further includes an accelerator pedal. The information indicating the completion of passing over the bump includes at least one of information on a brake operation by a user, information on a shift range-changing operation by the user, information on a running completing operation by the user, and information indicating that the amount of operation of the accelerator pedal by the user is a prescribed amount or smaller.

Preferably, the vehicle further includes a navigation system. The information indicating the completion of passing over the bump further includes information on movement of the vehicle based on a signal from the navigation system.

A method for controlling a vehicle according to the present invention is a method for controlling a vehicle that can run with driving force output from a rotating electric machine mounted thereon. The vehicle includes a drive device for driving the rotating electric machine. The method includes the steps of detecting whether the vehicle is passing over a bump on a road surface; and when the vehicle is passing over the bump, controlling the drive device such that an upper limit value of a running speed of the vehicle is restricted to a value lower than that when the vehicle is not passing over the bump.

### Advantageous Effects of Invention

According to the present invention, the vehicle that can run with driving force from a rotating electric machine can advantageously pass over a bump.

### BRIEF DESCRIPTION OF DRAWINGS

FIG. 1 is an overall block diagram of a vehicle according to the present embodiment.

FIG. 2 is a first diagram for illustrating a problem when the vehicle passes over a bump.

FIG. 3 is a second diagram for illustrating the problem when the vehicle passes over a bump.

FIG. 4 is a diagram for illustrating a method of detecting a bump in the present embodiment.

FIG. 5 is a diagram for explaining conditions for distinguishing between a slope and a bump.

FIG. 6 is a functional block diagram for illustrating control for passing over a bump that is executed by an ECU in the present embodiment.

FIG. 7 is a flow chart for illustrating in detail a control process for passing over a bump that is executed by the ECU in the present embodiment.

FIG. 8 is a diagram showing an exemplary relationship between an inclination angle of a road surface and a torque required to start the vehicle at the inclination angle, for use in determining a bump in S140 of FIG. 7.

### DESCRIPTION OF EMBODIMENTS

Embodiments of the present invention will be described hereinafter, with reference to the drawings. In the following description, the same components are denoted by the same symbols. The names and functions thereof are also the same. Accordingly, detailed description thereof will not be repeated.

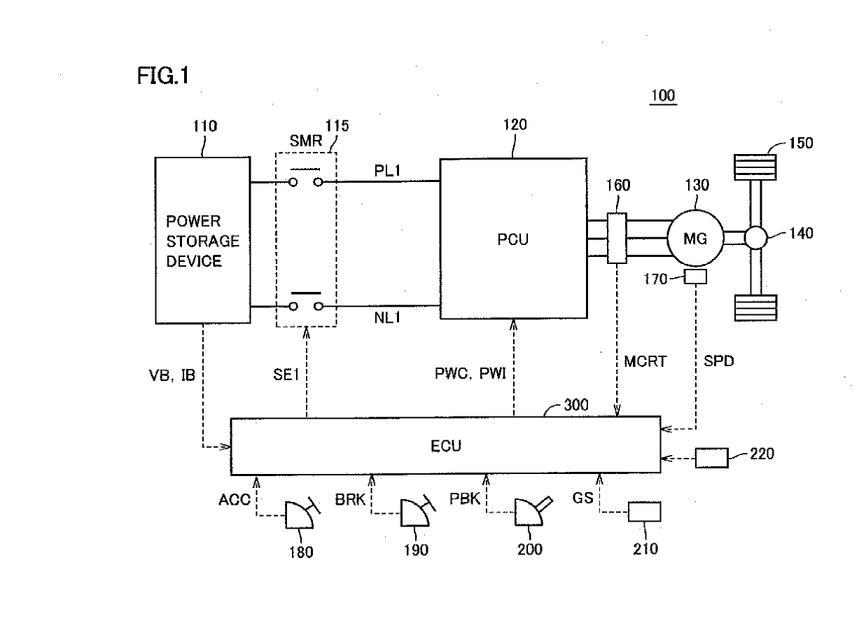

FIG. 1 is an overall block diagram of a vehicle 100 according to the present embodiment. Referring to FIG. 1, vehicle 100 includes a power storage device 110, a system main relay (hereinafter also referred to as SMR (System Main Relay)) 115, a PCU (Power Control Unit) 120 as a drive device, a motor generator 130, a power transmission gear 140, a driving wheel 150, and a control device (hereinafter also referred to as ECU (Electronic Control Unit)) 300.

Power storage device 110 is an electric power storing component configured to be chargeable and dischargeable. Power storage device 110 is configured to include a secondary battery such as a lithium ion battery, a nickel-metal hydride battery, or a lead-acid battery, or a power storage element such as an electric double layer capacitor, for example.

Power storage device 110 is connected via SMR 115 to PCU 120 for driving motor generator 130. Power storage device 110 supplies PCU 120 with electric power for generating driving force for vehicle 100. Power storage device 110 also stores electric power generated by motor generator 130. Power storage device 110 has an output of 200 V, for example.

A relay included in SMR 115 is inserted through each of power lines PL1 and NL1, which connect power storage device 110 and PCU 120. SMR 115 switches between supply and interruption of electric power between power storage device 110 and PCU 120, based on a control signal SE1 from ECU 300.

PCU 120 includes a converter, an inverter, and the like, although not shown. The converter is controlled by a control signal PWC from ECU 300, and converts voltage from power storage device 110. The inverter is controlled by a control signal PWI from ECU 300, and drives motor generator 130 with the electric power converted with the converter.

Motor generator 130 is an AC rotating electric machine, and is, for example, a permanent magnet type synchronous electric motor provided with a rotor having a permanent magnet embedded therein.

An output torque of motor generator 130 is transmitted through power transmission gear 140, which is formed of a reduction gear, a power split device, or the like, to driving wheel 150, causing vehicle 100 to run. At the time of a regenerative braking operation of vehicle 100, motor generator 130 can generate electric power by rotational force of driving wheel 150. The generated electric power is then converted by PCU 120 into electric power for charging power storage device 110.

Further, in a hybrid vehicle having an engine (not shown) mounted thereon in addition to motor generator 130, required vehicle driving force is generated by coordinated operation of the engine and motor generator 130. In this case, power storage device 110 can also be charged with electric power generated by rotation of the engine.

Specifically, vehicle 100 in the present embodiment represents a vehicle having an electric motor mounted thereon for generating vehicle driving power, and includes a hybrid car in which vehicle driving power is generated by an engine and an electric motor, an electric car and a fuel cell not having an engine mounted thereon, and the like.

A current sensor 160 is provided in a path that connects PCU 120 and motor generator 130. Current sensor 160 detects a current MCRT flowing through motor generator 130 and outputs the detected value to ECU 300.

Motor generator 130 is provided with a speed sensor 170 for detecting a signal associated with a rotation speed of motor generator 130. Speed sensor 170 includes a rotation angle sensor, for example, and detects a rotation angle of a rotor included in motor generator 130. Based on the detected rotation angle, speed sensor 170 detects a rotation speed of motor generator 130 and/or a rotation speed of driving wheel 150, and outputs a detected value SPD to ECU 300. In the case of detecting the rotation speed of driving wheel 150, speed sensor 170 may directly detect the speed of driving wheel 150, rather than the speed of motor generator 130.

Although not shown in FIG. 1, ECU 300 includes a CPU (Central Processing Unit), a storage device, and an input/output buffer, and inputs signals from various sensors and the like or outputs control signals to various devices, and also controls vehicle 100 and various devices. Such control can be performed not only by software processing, but also by dedicated hardware (electronic circuit).

ECU 300 receives detected values of a voltage VB and a current IB from a sensor (not shown) included in power storage device 110. ECU 300 calculates a state of charge (hereinafter also referred to as the SOC (State of Charge)) of power storage device 110, based on voltage VB and current IB.

ECU 300 receives operation signals from a user. These operation signals include an amount of operation ACC of accelerator pedal 180, an amount of operation BRK of a brake pedal 190, and an operation signal PBK of a parking brake 200.

ECU 300 receives a signal GS from an inclination sensor 210 provided in a car body for detecting an inclination of the car body. An acceleration sensor is used, for example, as inclination sensor 210.

A navigation system 220 may also be mounted on vehicle 100. From navigation system 220, ECU 300 receives vehicle information NAV including a position or movement information of vehicle 100.

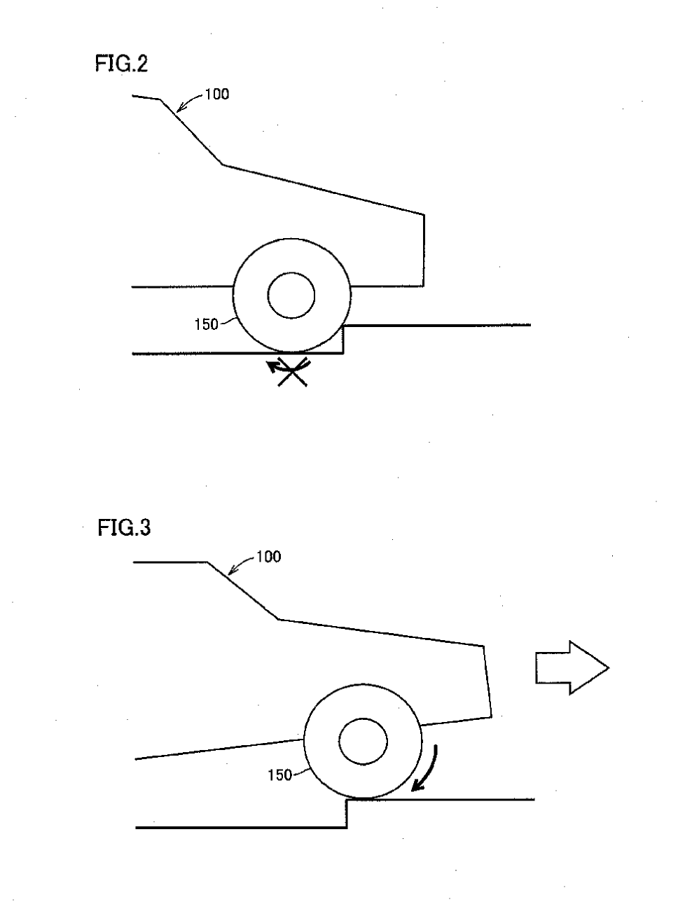

Consider a situation in which vehicle 100 as described above is approaching a bump as shown in FIG. 2, during running at a low speed such as parking, for example. At this time, driving wheel 150 (or a idler wheel (not shown)) may enter a so-called locked state with its rotation being stopped due to this bump. Here, the user generally increases the amount of operation of the accelerator pedal to achieve output of a torque required to pass over the bump. However, while an electric vehicle such as vehicle 100 or a hybrid vehicle is running only with driving force from a motor generator, namely, so-called EV (Electric Vehicle) running, current flows through coils of a stator with the rotation of the motor generator being stopped. In this case, if the accelerator pedal is excessively operated by the user, a large current intensively flows through the coil of a particular phase of the stator, which excessively heats the motor generator, thus posing the risk of an equipment failure, insulation deterioration, and the like.

In such a vehicle that can run only with driving force from the motor generator, therefore, when driving wheel 150 is placed in a locked state, current that flows through the motor generator may be restricted, that is, a restriction may be imposed on torque, in order to prevent an equipment failure or deterioration possibly caused by the excessive operation of the accelerator pedal.

At this time, the user tends to depress the accelerator pedal more than usual because of the torque restriction. As shown in FIG. 3, therefore, after the vehicle has passed over the bump and the torque restriction is released upon release of the locked state of driving wheel 150, an excessive torque may be required.

Thus, in vehicle 100 according to the present embodiment, when the driving wheel is placed in a locked state due to a bump, control for passing over a bump is executed to restrict the speed of the vehicle for a prescribed period even after the vehicle has passed over the bump. This control for passing over a bump will hereinafter be described in detail.

In the control for passing over a bump, it is necessary to determine whether or not the vehicle is approaching a bump portion.

Here, if the vehicle is approaching a bump, the driving wheel may be placed in a locked state as described above, and may not rotate even though the accelerator pedal is being operated. Such a state, however, can also occur when, for example, the vehicle is being held stationary with a torque from the motor generator against gravity on an uphill road, or when the vehicle is started on a slope. It is thus important to correctly determine whether the state is due to a bump or a slope, in which the driving wheel does not rotate despite operation of the accelerator pedal.

FIG. 4 is a diagram for illustrating a method of detecting a bump in the present embodiment. Referring to FIG. 4, when vehicle 100 is on a slope at an inclination angle θ, let “m” be a mass of vehicle 100 and “g” be a gravitational acceleration, a component G(θ) of gravity on vehicle 100 along an inclined plane can be expressed by the following Equation (1):

G(θ)=mg·sin θ (1)

Gravity component G(θ) increases as the inclination angle θ increases. When vehicle 100 is held stationary on the inclined plane with a torque from the motor generator, or when vehicle 100 climbs up a slope, it is necessary to output a torque that produces a force equal to or greater than gravity component G(θ).

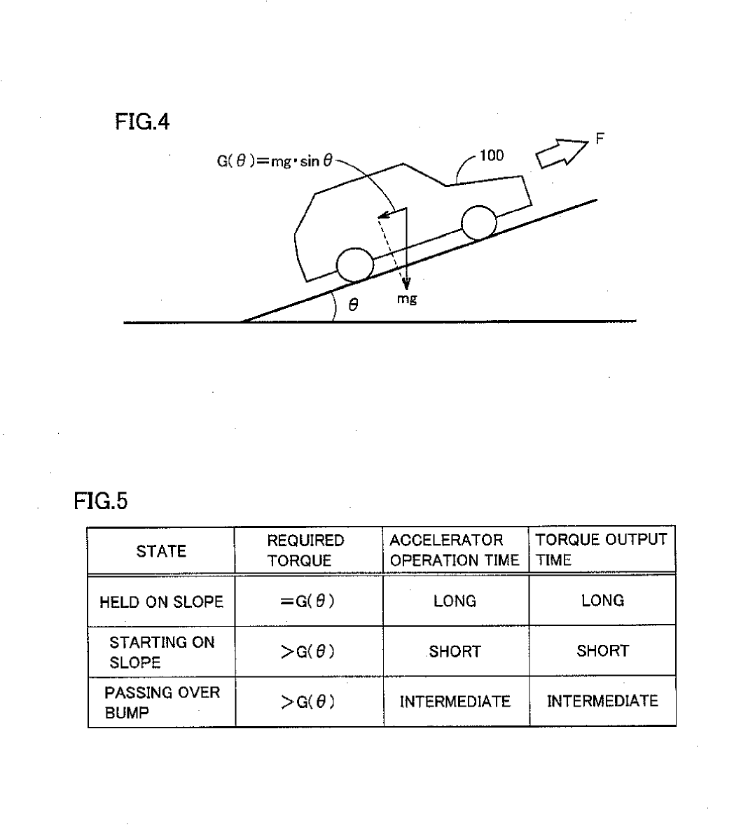

FIG. 5 is a diagram for explaining conditions for distinguishing between a slope and a bump. FIG. 5 shows, for each of the cases of “held on a slope”, “starting on a slope”, and “passing over a bump”, a torque required to perform each operation, an accelerator pedal operation time in outputting such a torque, and a duration time of the torque output.

Referring to FIG. 5, in the case of “held on a slope”, a force corresponding to gravity component G(θ) on the vehicle is a torque that can be output, and the accelerator pedal operation time and the duration time of the torque output are relatively long since it is necessary to maintain the position of the vehicle.

In the case of “starting on a slope”, since it is necessary to drive the vehicle forward, a torque for initiating rotation of the driving wheel is required, in addition to a torque against gravity component G(θ). The required torque is therefore greater than the torque corresponding to gravity component G(θ). In this case, however, since there is nothing that hinders rotation of the driving wheel such as a bump, the accelerator pedal operation time for outputting such a large torque and the torque output time are relatively short.

In the case of “passing over a bump”, since a torque for passing over a bump is required, a torque greater than the torque corresponding to the gravity component (θ) is needed, as in “starting on a slope”. It is noted that this case is not limited to a slope; therefore, in the case of a flat road (that is, θ=0°), gravity component G(θ) is zero.

In the case of “passing over a bump”, since it is necessary to continue output of such a large torque until the vehicle passes over a bump, both the accelerator pedal operation time and the torque output time tend to be shorter than those in “held on a slope”, but longer than those in “starting on a slope”.

It can therefore be determined whether or not the vehicle is passing over a bump, by considering whether or not the torque being required for the vehicle is greater than the torque corresponding to the component of gravity on the vehicle in accordance with the inclination of the road surface, and by considering a length of time during which the torque is required.

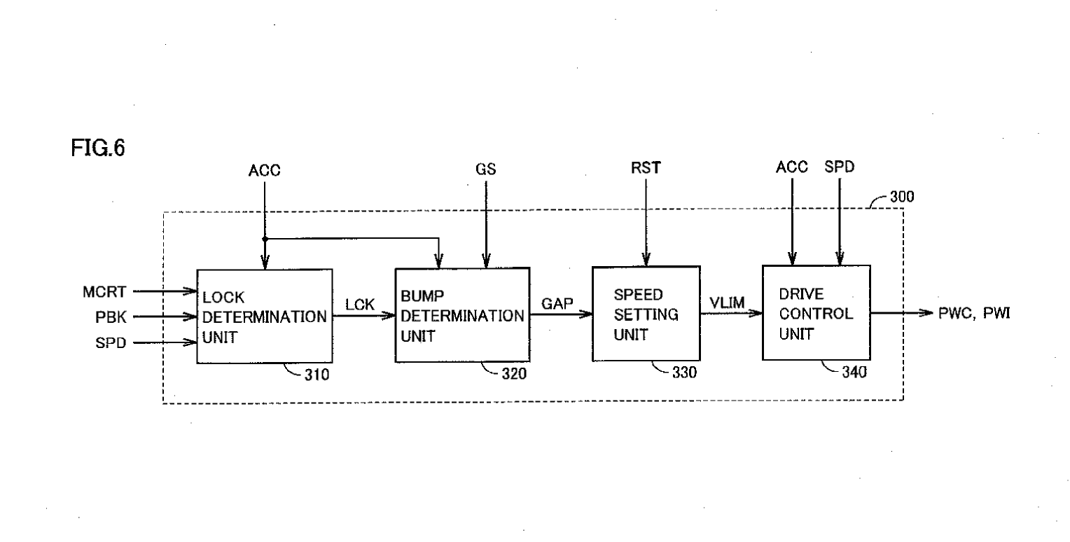

FIG. 6 is a functional block diagram for illustrating control for passing over a bump that is executed by ECU 300 in the present embodiment. Each of the functional blocks shown in the functional block diagram of FIG. 6 is implemented by hardware or software processing by ECU 300.

Referring to FIGS. 1 and 6, ECU 300 includes a lock determination unit 310, a bump determination unit 320, a speed setting unit 330, and a drive control unit 340.

Lock determination unit 310 receives current MCRT of motor generator 130 detected by current sensor 160, a rotation speed SPD of driving wheel 150 from speed sensor 170, amount of operation ACC of accelerator pedal 180, and operation signal PBK of parking brake 200.

Lock determination unit 310 determines whether driving wheel 150 is in a locked state or not, based on these pieces of information. Specifically, lock determination unit 310 determines that driving wheel 150 is in a locked state when accelerator pedal 180 is being operated with parking brake 200 being released, and/or when driving wheel 150 is not moving despite current flowing through motor generator 130. Here, the state of parking brake 200 is considered, in order to prevent an erroneous recognition caused by an operation in which, for example, when the vehicle is started on a slope, the user may perform an operation to maintain application of braking force with parking brake 200 until a torque is generated in driving wheel 150 such that the vehicle does not move backward, so as to prevent the vehicle from moving backward due to gravity.

For example, lock determination unit 310 sets a determination signal LCK in the ON state when driving wheel 150 is in a locked state, and sets determination signal LCK in the OFF state when driving wheel 150 is not in a locked state. Lock determination unit 310 then outputs determination signal LCK to bump determination unit 320.

Step determination unit 320 receives determination signal LCK from lock determination unit 310, amount of operation ACC of accelerator pedal 180, and signal GS indicating the inclination of the vehicle from inclination sensor 210.

As described with FIGS. 4 and 5, when driving wheel 150 is in a locked state, bump determination unit 320 determines whether the locked state of driving wheel 150 is due to a bump or not, based on an inclination of the road surface found from signal GS indicating the inclination, a required torque found from amount of operation ACC of accelerator pedal 180, and a duration time of the output of the required torque.

Step determination unit 320 sets a determination signal GAP indicating the presence/absence of a bump, and outputs the signal to speed setting unit 330. It is noted that, for example, determination signal GAP is set in the ON state when a bump is present, and is set in the OFF state when no bump is present.

Speed setting unit 330 receives determination signal GAP from bump determination unit 320, and sets a speed restriction value VLIM of vehicle 100. Specifically, when determination signal GAP is in the OFF state, that is, no bump is present, speed setting unit 330 sets, as speed restriction value VLIM, an upper limit value of the speed of the vehicle (vehicle speed) that is permitted during normal running. Conversely, when determination signal GAP is in the ON state, that is, a bump is present, speed setting unit 330 sets speed restriction value VLIM to be a speed sufficiently lower than the speed upper limit value of the vehicle speed during normal running, in order to prevent the speed from abruptly increasing after passing over the bump. Speed setting unit 330 then outputs speed restriction value VLIM to drive control unit 340.

It is noted that where speed restriction value VLIM is set to be lower than that during normal running, speed setting unit 330 returns speed restriction value VLIM to the speed upper limit value during normal running in response to reception of a release signal RST resulting from, for example, a brake operation with brake pedal 190 or parking brake 200, a shifting operation with a shift lever (not shown), a running completing operation with an ignition key or an ignition switch, the movement information of the vehicle included in vehicle information NAV from navigation system 220, information indicating that amount of operation ACC of accelerator pedal 180 is equal to or smaller than a prescribed amount, and the like. With respect to the condition that amount of operation ACC of accelerator pedal 180 is equal to or smaller than the prescribed amount, it is preferred to return speed restriction value VLIM to the speed upper limit value during normal running when amount of operation ACC of accelerator pedal 180 is zero.

Drive control unit 340 receives speed restriction value VLIM from speed setting unit 330, amount of operation ACC of accelerator pedal 180, and rotation speed SPD of driving wheel 150 from speed sensor 170. Drive control unit 340 generates control signals PWC, PWI for the converter and the inverter included in PCU 120 such that the required torque found from amount of operation ACC of accelerator pedal 180 is output from motor generator 130. At this time, drive control unit 340 controls the converter and the inverter such that the vehicle speed does not exceed speed restriction value VLIM set by speed setting unit 330, while performing feedback control of rotation speed SPD of driving wheel 150.

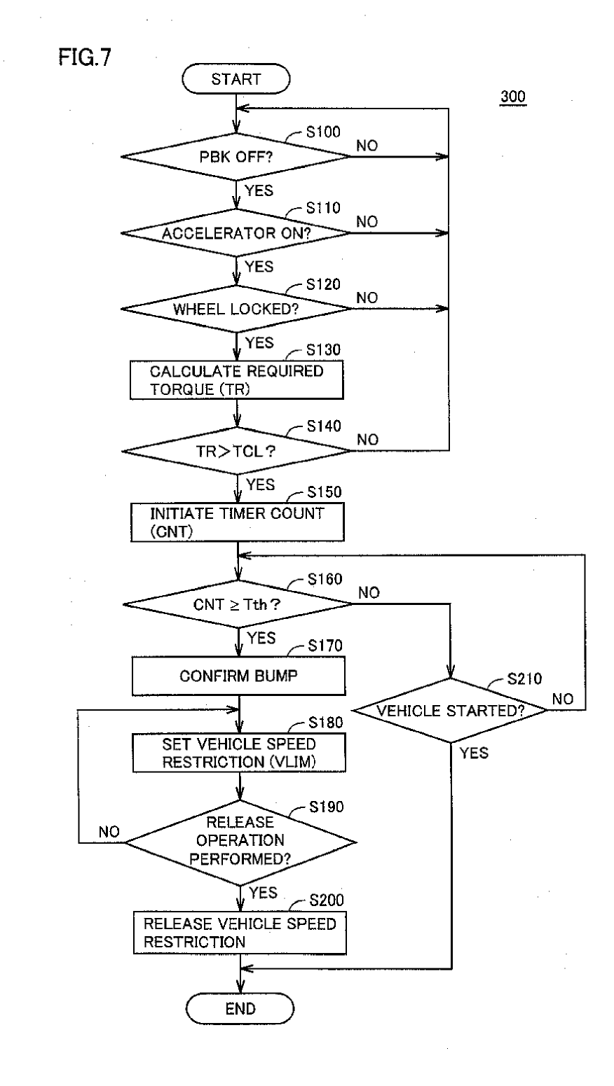

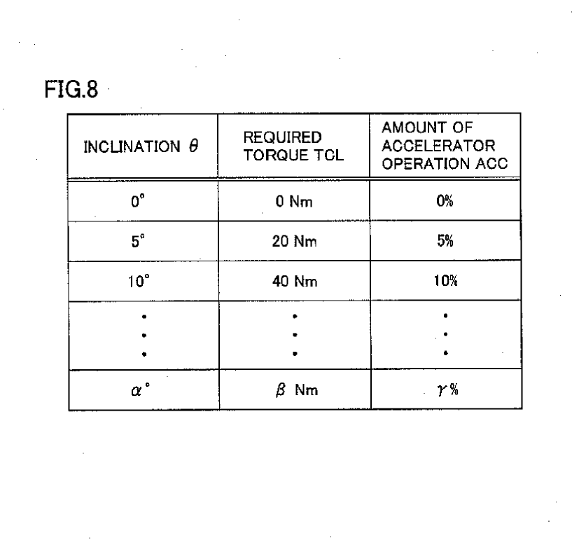

FIG. 7 is a flow chart for illustrating in detail a control process for passing over a bump that is executed by ECU 300. The flow chart shown in FIG. 7 is implemented by executing a program stored in advance in ECU 300 in prescribed cycles. Alternatively, for some steps, the process may be implemented by constructing dedicated hardware (electronic circuit).

Referring to FIGS. 1 and 7, ECU 300 determines in Step (“Step” is hereinafter abbreviated to “S”) 100 whether PBK is OFF or not, that is, parking brake 200 has been released or not.

When parking brake 200 has been released (YES in S100), the process proceeds to S110, where ECU 300 subsequently determines whether accelerator pedal 180 is being depressed or not, based on amount of operation ACC of accelerator pedal 180.

When accelerator pedal 180 is being depressed (YES in S110), the process proceeds to S120, where ECU 300 determines whether driving wheel 150 is in a locked state or not, based on rotation speed SPD of driving wheel 150 from speed sensor 170.

When driving wheel 150 is in a locked state (YES in S120), ECU 300 determines that vehicle 100 may be approaching a bump, and the process proceeds to S130, where ECU 300 calculates a required torque TR required by the user based on amount of operation ACC of accelerator pedal 180.

It is noted that when parking brake 200 has not been released (NO in S100), when accelerator pedal 180 is not being depressed (NO in S110), and when driving wheel 150 is not locked (NO in S120), it is unlikely that vehicle 100 is approaching a bump, and therefore, ECU 300 returns the process to S100.

After required torque TR is calculated in S130, ECU 300 subsequently determines in S140 whether or not the calculated required torque TR is greater than reference torque TCL, which is required to start the vehicle against gravity in a direction along the inclination angle of the road surface. Reference torque TCL is set based on signal GS from inclination sensor 210, using a map showing a relationship between inclination angle θ of the road surface and reference torque TCL, which has been found in advance through experiments or the like, as shown in FIG. 8. Alternatively, reference torque TCL may be found by calculation using the above-defined Equation (1) described with FIG. 4.

It is noted that, as shown in the map of FIG. 8, the relationship between reference torque TCL and amount of operation ACC of accelerator pedal 180 that can output the torque may be found in advance through experiments or the like. Then, based on amount of operation ACC of accelerator pedal 180 actually being operated by the user, it may be determined whether or not the required torque TR required by the user is greater than reference torque TCL. In this case, it is unnecessary to calculate required torque TR in S130.

When required torque TR is equal to or smaller than reference torque TCL (NO in S140), a torque sufficient to rotate driving wheel 150 is not being required, or the vehicle is being held on a slope. ECU 300 therefore determines that the vehicle 100 is not passing a bump, and returns the process to S100.

When required torque TR is greater than reference torque TCL (YES in S140), the process proceeds to S150, where ECU 300 initiates a counter CNT for measuring a time during which a torque exceeding reference torque TCL is required.

ECU 300 then determines in S160 whether or not a value of counter CNT has become equal to or greater than a reference time Tth that has been found in advance.

When counter CNT has not reached reference time Tth (NO in S160), the process proceeds to S210, where ECU 300 determines whether vehicle 100 has started or not, based on rotation speed SPD of driving wheel 150, for example.

When vehicle 100 has started (YES in S210), ECU 300 needs not restrict the vehicle speed, and thus completes the process.

When vehicle 100 has not started (NO in S210), ECU 300 returns the process to S160, where it waits for counter CNT to reach reference time Tth.

When counter CNT has reached reference time Tth (YES in S160), the process proceeds to S170, where ECU 300 determines that vehicle 100 is approaching a bump and the user is continuing operation of accelerator pedal 180 in order to pass over this bump, and sets determination signal GAP indicating the presence/absence of a bump in the ON state, as described with FIG. 6.

Then in S180, ECU 300 sets speed restriction value VLIM of the vehicle speed to a value sufficiently smaller than that during normal running. This suppresses an excessive increase in the speed of the vehicle, even when the user is depressing accelerator pedal 180 too much after the vehicle has passed over the bump.

Then in S190, ECU 300 determines whether or not a release operation has been performed by operating brake pedal 190, for example, as described with FIG. 6.

When a release operation has not been performed (NO in S190), the vehicle is still passing over the bump, or the user is continuing to depress accelerator pedal 180 after the vehicle has passed over the bump. ECU 300 therefore returns the process to S180, where it waits for the user to perform the release operation while maintaining the state in which speed restriction value VLIM is set to be small.

When the release operation has been performed (YES in S190), ECU 300 determines that the vehicle has completed passing over the bump. The process proceeds to S200, where ECU 300 returns speed restriction value VLIM to the speed upper limit value during normal running, and completes the process.

By performing control in accordance with the process as described above, it is possible to correctly determine that the vehicle is passing over a bump by distinguishing it from when the vehicle is being held on a slope or when the vehicle is starting on a slope. Moreover, it is also possible to prevent an excessive torque from being required after the vehicle has passed over the bump.

It is noted that the foregoing has described a configuration for reducing the setting of the speed restriction value when the vehicle is passing over a bump; however, rather than changing the setting of the speed restriction value, a configuration may be made for reducing the required torque or required output corresponding to the amount of operation of the accelerator pedal compared to that during normal running, which consequently reduces the upper limit value of the speed.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

100: vehicle; 110: power storage device; 115: SMR; 120: PCU; 130: motor generator; 140: power transmission gear; 150: driving wheel; 160: current sensor; 170: speed sensor; 180: accelerator pedal; 190: brake pedal; 200: parking brake; 210: inclination sensor; 220: navigation system; 300: ECU; 310: lock determination unit; 320: bump determination unit; 330: speed setting unit; 340: drive control unit; PL1, NL1: power line.

1. A vehicle that can run with driving force output from a rotating electric machine mounted thereon, comprising:
a drive device for driving said rotating electric machine; and
a control device for controlling said drive device,
when said vehicle is passing over a bump on a road surface, said control device controlling said drive device such that an upper limit value of a running speed of said vehicle is restricted to a value lower than that when said vehicle is not passing over a bump.

2. The vehicle according to claim 1,
further comprising an accelerator pedal, wherein
under a prescribed condition where a parameter associated with a rotation speed of a driving wheel of said vehicle is equal to or smaller than a prescribed value and an amount of operation of said accelerator pedal is greater than a prescribed amount of operation corresponding to an inclination of said vehicle, said control device determines that said vehicle is passing over said bump, and controls said drive device such that the upper limit value of the running speed of said vehicle is restricted to the value lower than that when said vehicle is not passing over said bump.

3. The vehicle according to claim 2, wherein
said control device determines that said vehicle is passing over said bump when said prescribed condition is met, and said prescribed condition lasts for a predetermined period.

4. The vehicle according to claim 1, wherein
said control device releases a restriction on the running speed of said vehicle, based on information indicating completion of passing over said bump.

5. The vehicle according to claim 4,
further comprising an accelerator pedal, wherein
said information indicating the completion of passing over said bump includes at least one of information on a brake operation by a user, information on a shift range-changing operation by the user, information on a running completing operation by the user, and information indicating that the amount of operation of said accelerator pedal by the user is a prescribed amount or smaller.

6. The vehicle according to claim 5,
further comprising a navigation system, wherein
said information indicating the completion of passing over said bump further includes information on movement of said vehicle based on a signal from said navigation system.

7. A method for controlling a vehicle that can run with driving force output from a rotating electric machine mounted thereon,
said vehicle including a drive device for driving said rotating electric machine,
said method comprising the steps of:
detecting whether said vehicle is passing over a bump on a road surface; and
when said vehicle is passing over said bump, controlling said drive device such that an upper limit value of a running speed of said vehicle is restricted to a value lower than that when said vehicle is not passing over said bump.
